(19) United States
(12) Patent Application Publication
(10) Pub. No.: US 2008/0293612 A1
(43) Pub. Date: Nov. 27, 2008

(54) Surfactant Systems for Surface Cleaning

(75) Inventors: Kenneth Edmund Kellar, Blue Ridge, VA (US); Christina Edwards, Boones Mill, VA (US)

Correspondence Address: NOVOZYMES NORTH AMERICA, INC., 500 FIFTH AVENUE, SUITE 1600, NEW YORK, NY, 10110, US

(73) Assignee: Novozymes Biologicals, Inc., Salem, VA (US)

(21) Appl. No.: 12/095,751

(22) PCT Filed: Dec. 19, 2006
(86) PCT No.: PCT/US2006/062274

§ 371 Date: Jun. 2, 2008

Related U.S. Application Data
(60) Provisional application No. 60/752,215, filed on Dec. 20, 2005.

(51) Int. Cl. C11D 1/83

(52) U.S. Cl. 510/405

(57) ABSTRACT

The present invention relates to aqueous surfactant systems that in diluted or undiluted form may be used for cleaning surfaces or may be used as an active cleaning base in various ready-to-use (or in-use) aqueous cleaning compositions suitable for surface cleaning. The invention also relates to a cleaning system comprising a surfactant system of the invention. According to the invention the cleaning efficacy of the surfactant system or cleaning system is increased by reducing or minimizing the size of the surfactants typically used in surfactant systems and reducing or minimizing the water solubility of the surfactant system.

### FIELD OF THE INVENTION

The present invention relates to aqueous surfactant systems that in diluted or undiluted form may be used for cleaning surfaces or may be used as an active cleaning base in various ready-to-use (or in-use) aqueous cleaning compositions suitable for surface cleaning. The invention also relates to methods of preparing aqueous surfactant systems of the invention as well as methods of increasing cleaning efficacy of surfactant systems and cleaning compositions suitable for surface cleaning.

### BACKGROUND OF THE INVENTION

Aqueous surfactant systems and surface cleaning compositions are commercially important products and have a wide field of utility in assisting in removal of dirt, grimes stains and soils from surfaces, including hard and soft surfaces.

Some aqueous surface cleaning compositions contain organic solvents. Organic solvents are undesirable in cleaning compositions for environmental reasons, but also in cleaning composition comprising, for instance, microorganisms, such as bacterial spores, as an active ingredient. However, sometimes it is necessary to include organic solvents in surface cleaning compositions in order to be able to provide a sufficiently good cleaning performance.

U.S. Pat. No. 5,951,784 concerns a hazardous ingredient free composition for cleaning automotive oils and grease stains from concrete.

WO 2005/049783 discloses an aqueous, dilutable hard surface cleaning composition comprising one or more anionic and/or nonionic surfactants, a thickener and an opacifying constituent.

U.S. Pat. No. 6,716,804 discloses a cleaner/degreaser composition comprising a) a water soluble ethoxylate, b) a water insoluble ethoxylate, and c) a component selected from the group consisting of amphoteric surfactants and anionic surfactants (or couplers), or mixtures thereof.

Even though a huge number of surfactant systems are known in the art there is nevertheless still a desire and need for especially aqueous surfactant systems which exhibit strong surface cleaning capabilities. Further, there is also a desire and need for surfactant systems free of organic solvents having at least equal surface cleaning capabilities as that of surfactant systems that contain organic solvents. There is also a need and desire for surfactant systems that do not need extreme pHs (i.e., either high or low) that at the same time have the same or better cleaning performance.

### SUMMARY OF THE INVENTION

The present invention relates to aqueous surfactant systems that in diluted or undiluted form may be used for cleaning surfaces or may be used as an active cleaning base in ready-to-use (or in-use) aqueous cleaning compositions suitable for surface cleaning. The aqueous surfactant system of the invention is in non-diluted and/or diluted form free of any visible surfactant precipitate and/or phase separation at storage and/or in-use conditions. In case of, for instance, a concrete cleaner, as concerned in Example 3 herein, suitable conditions would be temperatures in the range from 5° C. to 45° C. and pHs in the range from 8 to 10, preferably around pH 9. In other words, the required stability conditions depend on the final in-use conditions of the surfactant system or cleaning product. The actual surfactant content and composition in the surfactant system should be within a range close to the point where no surfactant precipitate and/or phase separation is visible. In other words, the surfactant content and composition should be close to the point where visible surfactant precipitate and/or phase separation disappears. In cases where the in-use temperature is higher the aqueous surfactant systems and/or cleaning compositions of the invention are also free of any visible surfactant precipitate and/or phase separation at in-use conditions as high as, e.g., between 60° C. to 70° C. determined at pH 7 or pH 9.

The gist of the invention is to maximize the cleaning efficacy of surfactant systems or cleaning systems by 1) reducing or minimizing the size of the surfactants typically used in surfactant systems and 2) reducing or minimizing the water solubility of the surfactant systems. The decrease in water solubility can according to one aspect of the invention be accomplished by following one or a combination of the following two approaches:

a) introducing salt into the surfactant system,

b) introducing a water-insoluble surfactant into the surfactant system.

Reducing or minimizing the size of the surfactant molecules decrease the time required for diffusion from the solution to the appropriate interface, thereby increasing cleaning performance.

Reducing or minimizing the solubility of the surfactant system in water increases the adsorption efficiency of the surfactant system at the appropriate interfaces, thereby increasing cleaning performance. In other words, reducing or minimizing the solubility of the surfactants increases the wetting power of the surfactant system with respect to the surface that the surfactant system is applied to. This increases the cleaning performance.

Therefore, in the first aspect the invention relates to aqueous surfactant systems comprising one or more anionic surfactants and one or more nonionic surfactants. The surfactants and the ratio between the surfactants are chosen in order to provide an aqueous surfactant system free of any visible precipitate and/or phase separation under storage and/or in-use conditions and further in order to provide strong cleaning efficacy.

In the second aspect the invention relates to aqueous surfactant systems comprising one or more anionic surfactants and one or more salts, wherein one or more salts are present in an amount from 0.5 to 10 wt. %.

In the third aspect the invention relates to aqueous cleaning compositions comprising a surfactant system of the invention.

In the fourth aspect the invention relates to methods of preparing aqueous surfactant systems comprising one or more anionic surfactants and one or more nonionic surfactants, comprising the steps of

a) preparing an aqueous solution having a fixed concentration of surfactant, and

b) adding salt until the salt concentration is in the range between 25% less than the concentration point where no surfactant precipitate and/or phase separation is visible in the aqueous solution, and 25% more than the concentration point where no surfactant precipitate and/or phase separation is visible in the aqueous solutions or the salt concentration point where no surfactant precipitate and/or phase separation is visible in the aqueous solution.

In the fifth aspect the invention relates to the use of aqueous surfactant systems of the invention or aqueous cleaning compositions of the invention for cleaning hard or soft surfaces.

In the final aspect the invention relates to methods of increasing the cleaning efficacy of surfactant systems or cleaning compositions comprising one or more anionic surfactants and one or more nonionic surfactants, comprising the step of reducing the water solubility of the surfactant system or cleaning composition by

a) introducing salt into the surfactant system or cleaning composition, and/or

b) introducing a water insoluble surfactant into the surfactant system or cleaning composition.

The term “surfactant” means a molecule that belongs to a class of molecules having a hydrophilic group (or groups) and a hydrophobic group (or groups) that exhibit surface activity when the relative amounts of hydrophilic and hydrophobic parts are appropriate.

A “water soluble surfactant” means a surfactant that has solubility in water of more than 7% (on a weight/weight basis) at room temperature.

A “water insoluble surfactant” means a surfactant that has a solubility in water of less than 7% (on a weight/weight basis) at room temperature, preferably less than 2%, especially completely insoluble.

A “salt” means an inorganic salt selected from the group consisting of metal ion carbonates, such as sodium carbonate, sodium bicarbonate or the like.

### BRIEF DESCRIPTION OF THE DRAWING

FIG. 1 shows that Floor Cleaner 1 can spontaneously displace oil and dirt from a hard surface.

### DETAILED DESCRIPTION OF THE INVENTION

The present invention relates to aqueous surfactant systems that in diluted or undiluted form may be used for cleaning surfaces or may be used as active cleaning base in ready-to-use (or in-use) aqueous cleaning compositions suitable for surface cleaning.

### Aqueous Surfactant Systems

Aqueous surfactant systems known in the art, suitable as an active cleaning base in aqueous cleaning compositions, suffer from a number of deficiencies. Even though some known surfactant systems might be stable under storage conditions, they may not be stable at in-use conditions, e.g., when the surfactant system is diluted in hot water, and/or may not provide good surface cleaning.

It is known that the cleaning efficacy (or detergency) increases greatly in the region of the cloud point (M. J. Schwuger, Zur Kenntnis der Zusammenhänge zwischen Adsorption und Washwirkung von Tensiden, Chemie-Ing.-Techn. 43: 705-710 (1971)). It is to be understood that according to the present invention the cloud point is not matched with the temperature where the surfactant system is used for cleaning.

The present invention provides aqueous surfactant systems that may be used as a ready-to-use (in-use) surface cleaner or may be suitable as cleaning base in aqueous cleaning compositions of the invention. Surfactant systems of the invention are stable and have good cleaning efficacy. No surfactant precipitate and/or phase separation is visible at storage condition from 5° C. to 45° C. at pH 6-10, such as pH 7 or pH 9. In a preferred embodiment the surfactant systems are also stable at in-use conditions at about 60° C. or more, such as 65° C. at pHs in the range from 6-10, such as around pH 7 or pH 9. In a preferred embodiment the aqueous surfactant systems or aqueous cleaning compositions of the invention are free of any solvents and have a cleaning efficiency which at least equals that of solvent containing surfactant systems and cleaning compositions suitable for surface cleaning.

The primary process involved in cleaning of hard surfaces is the adsorption of surfactant (or surfactants) at the appropriate interfaces. When more than one surfactant is used a film comprised of the different surfactants will be adsorbed. In large part, the same physical factors like solubility of the surfactant and the addition of salt and/or water-insoluble nonionic surfactants, which decrease the critical micelle concentration of a surfactant system, increase the adsorption of surfactant to an interface, and therefore should enhance cleaning, Additionally, since cleaning (or detergency) is not generally an equilibrium process, surfactant molecules that can diffuse to the interface more rapidly, provided that they have adequate adsorption to the interface, will be the most effective cleaning agents. Consequently, surfactants with the most compact structure (smallest size) with the lowest possible critical micelle concentration (or solubility) provide the most effective cleaning.

Reducing or minimizing the size of the surfactant molecules decreases the time required for diffusion from the solution to the appropriate interface, thereby increasing cleaning performance.

Further, reducing or minimizing the solubility of the surfactant system in water increases the adsorption efficiency of the surfactant system at the appropriate interfaces, thereby increasing cleaning performance. In other words, reducing or minimizing the solubility of the surfactants increases the wetting power of the cleaning composition with respect to the surface that the surfactant system or in-use cleaning composition is applied to, and this increases the cleaning performance.

In the first aspect the invention relates to aqueous surfactant systems comprising one or more anionic surfactants and one or more nonionic surfactants. The surfactant systems are free of visible precipitate from surfactants and/or phase separation at temperatures between 5 and 45° C., preferably between 40 and 45° C. determined at pH 7 or pH 9. In a preferred embodiment the systems are also stable at in-use conditions at 60° C., preferably 65° C., more preferably 67° C., even more preferably 68° C., even more preferably 69° C., especially at a temperature of 70° C. determined at pH 7 or pH 9.

In one embodiment the surfactant system comprises two or more nonionic surfactants and an anionic surfactant. In one embodiment one of the nonionic surfactants is a water insoluble surfactant. Further, in another embodiment the surfactant system comprises two or more water-soluble nonionic surfactants and one water-insoluble nonionic surfactant. Further, the surfactant system may also comprise one water-soluble anionic surfactant, one water-soluble nonionic surfactant and one water-insoluble nonionic surfactant.

The ratio between anionic surfactant and nonionic surfactant may in an embodiment be 10:1 to 1:10, preferably 10:1 to 1:1, more preferably from 8:1 to 1:1, even more preferably 6:1 to 1:1. In a preferred embodiment the surfactant system contains a water soluble anionic surfactant and/or a water insoluble anionic surfactant. Examples of suitable anionic surfactants are given in the “Surfactants”-section below. Water soluble anionic surfactants are preferred. The nonionic surfactant may be a water insoluble nonionic surfactant or a water soluble nonionic surfactant, or mixtures thereof. Examples of suitable nonionic surfactants are given in the “Surfactants”-section below. In an embodiment the ratio between anionic surfactant and water insoluble nonionic surfactant is in the range from 10:1 to 1:10, preferably from 10:1 to 1:1, more preferably from 8:1 to 1:1, more preferably from 4:1 to 1:1. In a preferred embodiment the ratio between the water soluble nonionic surfactant and water insoluble nonionic surfactant is in the range from 10:1 to 1:10, preferably from 1:10 to 1:1, more preferably from 1:6 to 1:1. In an embodiment the ratio between anionic surfactant and total amount of nonionic surfactant is 10:1 to 1:10, preferably 10:1 to 1:1, more preferably 6:1 to 1:1.

In the second aspect the invention relates to an aqueous surfactant system comprising one or more anionic surfactants and one or more salts, wherein one or more salts are present in an amount from 0.5 to 10 wt. %. In a preferred embodiment the anionic surfactant is water soluble. However, the anionic surfactant may also be water insoluble. Examples of suitable anionic surfactants are given below in the “Surfactants”-section. The surfactant system may also further comprise one or more nonionic surfactants. The nonionic surfactant may preferably be water soluble, but may also be water insoluble. In an embodiment the surfactant system comprises a combination of water soluble and water insoluble nonionic surfactants. Examples of suitable nonionic surfactant are given below in the “Surfactants”-section. In a preferred embodiment water soluble anionic surfactant(s) and water soluble nonionic surfactant(s) are present in a ratio between 1:20 and 2:1, preferably 1:12 to 1:1, especially 1:10 to 1:5. The ratio between the anionic surfactant(s) and the nonionic surfactant(s) may in an embodiment of the invention be between 1:20 to 2:1, preferably 1:12 to 1:1, especially 1:10 to 1:5. Examples of suitable salts are given in the “salts”-section below.

### Surfactants

The aqueous surfactant system of the invention includes one or more anionic surfactants and one or more nonionic surfactants. This section provides a number of examples of surfactants suitable according to the invention. The different kind of surfactants are chosen and comprised in certain ratios in order to reduce, preferably minimize the water solubility of the surfactant system and provide good cleaning efficacy.

### Anionic Surfactants

The surfactant system of the invention comprises one or more anionic surfactants. The anionic surfactant(s) may be either water soluble or water insoluble. Water soluble anionic surfactants are preferred.

Examples of suitable water soluble anionic surfactants include those selected from the group consisting of alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonate, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-N-alkyltaurates, and alkyl carboxylates.

In an embodiment the alkyl sulfate is a sodium, potassium, ammonium, ethanolamine, or magnesium salt, preferably with a carbon chain length from 6 units to 20 units. In a preferred specific embodiment the alkyl sulfate is sodium dodecyl sulfate (sodium lauryl sulfate).

In an embodiment the sulfated ethoxylate of fatty alcohol is a sodium, potassium, ammonium, ethanolamine, or magnesium salt, preferably with 1 to 6 oxyethylene groups and having a carbon chain length with from 6 to 20 units. In a preferred specific embodiment the sulfated ethoxylate of fatty alcohol is sodium laureth sulfate (sodium lauryl ether sulfate).

In an embodiment the alkyl sulfonate is linear or branched and is a sodium, potassium, ammonium, or magnesium salt, with a carbon chain length from 6 to 20 units. In a specific preferred embodiment the alkyl sulfonate is sodium octyl sulfonate. Sodium octyl sulfonate is preferred according to the invention mainly for two reasons. First, it is a small surfactant that is powdery and non-sticky. This allows a powdery, non-sticky residue to form upon evaporation of the cleaning composition of the invention. A powdery, non-sticky residue is less likely to attract dirt and cause rapid re-soiling of the cleaned area of, e.g., carpet. Second, it is preferred according to the invention to use a small-molecule hydrotrope typified by sodium xylene sulfonate, which is also used to provide a powdery, non-sticky residue when the liquid formulation evaporates. The reason sodium octyl sulfonate is preferred is that it provides surfactancy: significant surface and interfacial reduction, as well as having the ability to solubilize material via micelle formation.

In an embodiment the alkyl benzene sulfonate is linear or branched and is a sodium, potassium, ammonium, or magnesium salt, with a carbon chain length (attached to benzene ring) from 6 units to 20 units. In a preferred specific embodiment alkyl benzene sulfonate is sodium dodecyl benzene sulfonate.

In a preferred embodiment the alpha-olefin sulfonate is a sodium, potassium, ammonium, or magnesium salt, having a carbon chain length (attached to benzene ring) from 6 to 20 units.

In a preferred embodiment the sulfosuccinate is a sodium, potassium, or ammonium salt, with a carbon chain length from 4 to 16 units. In a preferred specific embodiment the sulfosuccinate is disodium octyl sulfosuccinate.

In a preferred embodiment the alkyl diphenyloxide sulfonate is a sodium, potassium, or ammonium salt, with a carbon chain length from 6 to 22 units.

In a preferred embodiment the alkyl naphthalene sulfonate is a sodium, potassium, or ammonium salt, with a carbon chain length from 0 to 10 units. In a specific preferred embodiment the alkyl naphthalene sulfonate is sodium butyl naphthalene sulfonate.

In a preferred embodiment the ethoxylated sulfosuccinate is a sodium, potassium, or ammonium salt, with a carbon chain length from 6 to 20 units and having 1 to 6 oxyethylene groups. In a preferred specific embodiment the ethoxylated sulfosuccinate is 3 mole ethoxylated sodium lauryl sulfosuccinate.

In a preferred embodiment the phosphate ester is a sodium, potassium, or ammonium salt, with a carbon chain length from 6 to 22 units.

In a preferred embodiment the alkyl carboxylate is a sodium, potassium, or ammonium salt, with a carbon chain length from 6 to 22 units. In a preferred specific embodiment the alkyl carboxylate is sodium stearate.

In a preferred embodiment the N-acyl-N-alkyltaurate is a sodium, potassium, and ammonium, calcium, or magnesium salt, with a carbon chain length from 6 to 22 units.

In a preferred embodiment the N-alkyl sarcoside is a sodium, potassium, or ammonium salts, with a carbon chain length from 6 to 22 units. In a preferred specific embodiment the N-alkyl sarcoside is sodium lauroyl sarcoside.

In a preferred embodiment the benzene-, toluene-, xylene-, or cumene sulfonate is a sodium salt. In a preferred embodiment the lignin sulfonate has a molecular weight of 1000 to 20,000.

### Nonionic Surfactants

A surfactant system of the invention may comprise at least one or more nonionic surfactant, which may be either water insoluble or water soluble.

### Water Insoluble Nonionic Surfactants

Water insoluble nonionic surfactants are more likely to adsorb or penetrate water insoluble stains (like ink or motor oil) than water soluble nonionic surfactants. The presence of a polar part tends to make insoluble stains more soluble in aqueous solution, thereby making the stains easier to remove. Therefore in an embodiment the insoluble surfactant include one or more polar parts. By extension, making the aqueous surfactant system as insoluble in water as possible is believed to increase the partitioning or adsorption of at least the most insoluble surfactant components into the water insoluble stain, thereby enhancing cleaning efficacy. It should be noted, that although these molecules have very low solubility in water, they all contain at least one polar part, meaning they have some tendency to at least associate with water.

Contemplated water insoluble surfactants include alkyl and aryl: glycerol ethers, glycol ethers, ethanolamides, sulfoanylamides, alcohols, amides, alcohol ethoxylates, glycerol esters, glycol esters, ethoxylates of glycerol ester and glycol esters, sugar-based alkyl polyglycosides, polyoxyethylenated fatty acids, alkanolamine condensates, alkanolamides, tertiary acetylenic glycols, polyoxyethylenated mercaptans, carboxylic acid esters, and polyoxyethylenated polyoxyproylene glycols. Also included are EO/PO block copolymers (EO is ethylene oxide, PO is propylene oxide), EO polymers and copolymers, polyamines, and polyvinylpynolidones.

In an embodiment of the invention the water insoluble nonionic surfactant is an ethoxylate. It is preferred to have a carbon chain length as small as possible in the hydrophobic region in order to obtain optimal cleaning. In a preferred embodiment the water insoluble nonionic surfactant is an alcohol ethoxylate.

Alcohol ethoxylates have the formula: RO(CH₂CH₂O)ₙH, where R is the hydrocarbon chain length and n is the average number of moles of ethylene oxide. In a preferred embodiment the alcohol ethoxylate is a linear primary, or secondary or branched alcohol ethoxylate where R has a chain length from C9 to C16 and n ranges from 0 to 5. In an especially preferred embodiment of the invention the water insoluble nonionic surfactant is a linear primary, or secondary or branched alcohol ethoxylate having the formula: RO(CH₂CH₂O)ₙH, wherein R has a chain length of C9-11 and n is 2.7.

Examples of commercially available water insoluble surfactants can be found in the following. One class is the alkyl polyglycosides (or APGs) that are derived from natural resources and therefore friendly to the environment. Another class includes glycol ethers, particularly those with low vapor pressure (less than 0.1 mm Hg at 20° C.) so that they are considered as “Low Vapor Pressure VOC” by the California Air Resources Board, and examples are given below.

Glycol Ethers

| | |
|---|---|
| DOWANOL ™ TPnB | Tripropylene Glycol n-Butyl Ether |
| DOWANOL ™ DPnB | Dipropylene Glycol n-Butyl Ether |
| DOWANOL ™ pph | Propylene Glycol Phenyl Ether |
| DOWANOL ™ Eph | Ethylene Glycol Phenyl Ether |
| Hexyl CELLOSOLVE ™ | Ethylene Glycol Hexyl Ether |
| Hexyl CARBITOL ™ | Diethylene Glycol Hexyl Ether |
| Butyl CARBITOL ™ Acetate | Diethylene Glycol n-Butyl Ether Acetate |

Alcohol Ethoxylates

| | Average Carbon | Average Ethoxylation |
|---|---|---|
| | Chain Length | Number |
| Tomadol ™ 91-2.5 | 9-11 | 2.7 |
| Alfonic ™ 1214GC-3 | 12-14 | 3 |
| Hetoxol ™ TD-3 | 13 | 3 |
| Tergitol ™ 15-S-3 | 12-14 | 3 |
| Bio-Soft ™ N23-3 | 12-13 | 3 |
| Bio-Soft ™ AE-1 | 12 | 1 |
| Bio-Soft ™ AE-2 | 12 | 2 |
| Bio-Soft ™ AE-3 | 12 | 3 |
| Bio-Soft ™ N1-3 | 11 | 3 |
| Bio-Soft ™ N91-2.5 | 9-11 | 2.7 |

For instance, of the above commercially available water insoluble surfactants Tomadol 91-2.5 and Bio-Soft N91-2.5 are preferred because the hydrophobic region contains only 9-11 carbon atoms. Therefore, they will diffuse to the interface the fastest and offer the best cleaning efficacy. However, dependent on the system and the application there may be reasons for not using these surfactants. For example, it may be that the surfactant content has to be present in extremely low concentration. e.g., for environmental reasons. In such case, the “original” surfactant system that the Bio-Soft N91-2.5 would be added to would likely not be very small, because very small surfactants have low critical micelle concentrations, and it is usually best if the surfactants can be present in a concentration above the critical micelle concentration. Consequently, the “original” surfactant system would likely contain larger surfactants, with a higher number of carbon atoms in the hydrophobic region, to help ensure that the surfactant content is above the critical micelle concentration. In this case, 12-13 carbons are needed and Bio-Soft™ N23-3 would be preferred over Bio-Soft N91-2.5.

### Water Soluble Nonionic Surfactants

Water soluble nonionic surfactants typically have a higher ethylene oxide content in the hydrophilic region of the surfactant in comparison to water insoluble nonionic surfactants.

In a preferred embodiment the water soluble nonionic surfactant is a linear primary, or secondary or branched alcohol ethoxylate having the formula: RO(CH₂CH₂O)ₙH, wherein R is the hydrocarbon chain length and n is the average number of motes of ethylene oxide. In a preferred embodiment R is linear primary or branched secondary hydrocarbon chain length in the range from C9 to C16 and n ranges from 6 to 13. Especially preferred is the alcohol ethoxylate where R is linear C9-C11 hydrocarbon chain length, and n is 6.

Examples of commercially available water soluble nonionic alcohol ethoxylate surfactants include Neodol™ 91-6, Tomadol™ 91-6, or Bio-Soft™ N23-6.5.

Tomadol™ 91-6 is a preferred water soluble nonionic surfactant for cleaning composition used for concrete cleaning. The reason is that it is a small surfactant with good interfacial tension lowering ability.

### Combination of Nonionic Surfactants

Combination of commercially available nonionic surfactant pair include Tomadol 91-2.5 (water insoluble) and Tomadol™ 91-6 (water soluble), and Bio-Soft N23-3 (water insoluble) and Bio-Soft N23-6.5 (water soluble).

The reason above mentioned combination are suitable according to the invention is mainly due to attaining a pair where the surface or interfacial tension is lowered. To expand, if a pair of surfactants is chosen, it is preferred that the lengths of the hydrocarbon chains are equal to attain maximum decrease in surface or interfacial tension to enhance cleaning efficacy. However, in general it is preferred to use the surfactant molecules as small as possible.

According to the present invention the total amount of surfactant in the surfactant system or cleaning composition may differ dependent on the surfactant system or cleaning composition and the use thereof. For instance if the surfactant system or cleaning composition is for carpet spot remover the total amount of surfactant is around 2 wt. % (see Example 1). However, if the surfactant system or in use cleaning composition is a concentrated concrete cleaner (See Example 3) the total surfactant amount is significantly higher. Therefore, according to the invention the amount of total amount of surfactant may be as low as 0.5 wt. % or lower and as high at 90 wt. %. Therefore, in embodiments of the invention the total amount of surfactant may be between 0.5 and 50 wt. %, or between 1 and 20 wt. %, or between 1 and 5 wt. %, or around 2 wt. % of the surfactant system or cleaning composition.

### Salts

The salt used in a surfactant system of the invention may be any salt, but is preferably a salt selected from the group consisting of alkali metal salts of nitrates, acetates, chlorides, bromides, iodides, sulfates, hydroxides, carbonates, hydrogen carbonates, phosphates, sulfides, and sulfites; ammonium salts of nitrates, acetates, chlorides, bromides, iodides, sulfates, hydroxides, carbonates, hydrogen carbonates (also called bicarbonates), phosphates, sulfides, and sulfites; alkaline earth metal salts of nitrates, chlorides, bromides, iodides, sulfates, sulfides, and hydrogen carbonates; manganese, iron, copper, and zinc salts of nitrates, acetates, chlorides, bromides, iodides, and sulfates; citrates and borates.

Especially contemplated are carbonates, in particular sodium carbonate and/or sodium bicarbonate. In a specific embodiment the ratio between sodium carbonate and sodium bicarbonate is between 1:10 to 10:1.

The total amount of salt is preferably between 0.8 to 8 wt. %, preferably 1-5 wt. % of the surfactant system or final in-use cleaning composition.

### Other Components

A surfactant system or a cleaning composition of the invention may further include other components, which may depend on the surface to be cleaned.

In case the surface is a hard surface such as concrete a corrosion inhibitor may be added.

For all cleaners, preservatives such as biocides, including Nipacide™, and chelating agents such as EDTA, may be included.

The cleaning composition may further comprise bacteria spores or enzymes. Preferably, the bacteria spores are from the genus Bacillus and the enzyme is selected from the group consisting of a amylase, cellulase, lipase, and protease, or mixtures thereof.

### Aqueous Cleaning Composition

An aqueous cleaning composition of the invention may comprise an aqueous surfactant system of the invention. The surfactant system may be used as active cleaning base. The aqueous cleaning composition may be used “as is” or may be prepared by the end-user to a desired composition for cleaning of surfaces by the appropriate dilution and the addition of salts if necessary. Aqueous cleaning compositions of the invention are stable in undiluted form and under “in-use” conditions. In-use conditions may vary, but typically the cleaning composition is added to hot water, which means at temperatures around 60° C. or more. The pH of a cleaning composition of the invention may also vary dependent on the use, but may typically be in the range from 7-11, preferably between 8 and 10, especially around pH 9.

The aqueous cleaning composition may be used for cleaning surfaces including hard and soft surfaces.

Examples of contemplated hard surfaces include concrete, metal, glass, ceramic, plastic, linoleum and similar surfaces. Hard surfaces are found in toilets, shower stalls, bathtubs, sinks, countertops, walls, floors and also include road surfaces.

Examples of contemplated soft surfaces include carpet, furniture, upholstery fabric, slippers, clothing and other fibrous materials.

The concentrated cleaning composition may, for instance, be diluted by the end-user in the ratio from 1:1 to 1:2000 (cleaning composition: water), preferably in a ratio of 1:1 to 1:250 (cleaning composition: water). Also, the end-user may, if necessary, add salt to the diluted product to obtain the required cleaning efficacy as is illustrated in Example 3 (see Table 4).

The cleaning composition of the invention is in a preferred embodiment solvent free, but may also contain one or more organic solvents, such as isopropyl alcohol.

The aqueous cleaning composition of the invention may be suitable for removal of grease and/or oily stains from hard or soft surfaces.

### A Method of Preparing an Aqueous Surfactant System or Cleaning Composition by Adding Salt

In an aspect the invention relates to a method of preparing an aqueous surfactant system or cleaning composition comprising one or more anionic surfactants and one or more nonionic surfactants, comprising the steps of

a) preparing an aqueous solution having a fixed concentration of surfactant, and

b) adding salt until the salt concentration is in the range between 25% less than the concentration point where no surfactant precipitate and/or phase separation is visible in the aqueous solution, and 25% more than the concentration point where no surfactant precipitate and/or phase separation is visible in the aqueous solution.

In an embodiment the anionic surfactant is water soluble anionic surfactant and/or water insoluble anionic surfactant, and the nonionic surfactant is water soluble or water insoluble. A preferred combination is a water soluble anionic surfactant and a water soluble nonionic surfactant. Examples of suitable surfactants and ratios can be found in the “Surfactants”-section and “Aqueous Surfactant System”-section above. Examples of suitable salts and salt ratios can be found in the “Salts”-section above.

According to this aspect of the invention the point where surfactant precipitate and/or phase separation is visible may be determined at a temperature between 5 and 45° C. at pH 7 or pH 9, such as between 40 and 45° C. at pH 7 or pH 9. In case of surfactant systems having different in-use conditions the point where surfactant precipitate and/or phase separation is visible may be determined at a temperature between 60 and 70° C. at pH 7 or pH 9, preferably 65° C., more preferably 67° C., more preferably 68° C., even more preferably 69° C., especially 70° C. at pH 7 or pH 9.

In a preferred embodiment the salt concentration is in the range between 20%, preferably 10%, especially 5%, less than the concentration point where no surfactant precipitate and/or phase separation is visible in the aqueous solution, and 20%, preferably 10%, especially 5%, more than the concentration point where no surfactant precipitate and/or phase separation is visible in the aqueous solution.

In another preferred embodiment the salt concentration is in the range between 25%, preferably 20%: more preferably 10%, especially 5%, less than the concentration point where no surfactant precipitate and/or phase separation is visible in the aqueous solution, and the concentration point where no surfactant precipitate and/or phase separation is visible in the aqueous solution.

The total amount of surfactant in the surfactant system or cleaning composition may differ dependent on the surfactant system or cleaning composition and the use thereof. For instance if the surfactant system or cleaning composition is for carpet spot remover the total amount of surfactant is around 2 wt. % (see Example 1). However, if the surfactant system or in use cleaning composition is a concentrated concrete cleaner (See Example 3) the total surfactant amount is significantly higher. Therefore, according to the invention the amount of total amount of surfactant may be as low as 0.5 wt. % or lower and as high at 90 wt. %. Therefore, in embodiments of the invention the total amount of surfactant may be between 0.5 and 50 wt. %, or between 1 and 20 wt. %, or between 1 and 5 wt. %, or around 2 wt. % of the surfactant system or cleaning composition.

### A Method of Preparing an Aqueous Surfactant System or Cleaning Composition by Adding Water Insoluble Surfactant

The invention also relates to a method of preparing an aqueous surfactant system or cleaning composition comprising one or more anionic surfactants and one or more nonionic surfactants, comprising the steps of

a) preparing an aqueous solution having a fixed concentration of water soluble anionic surfactant and/or water soluble nonionic surfactant,

b) adding one or more water insoluble surfactants until the concentration of water insoluble surfactants is in the range between 25% less than the concentration point where no precipitate of water insoluble surfactant and/or phase separation is visible in the aqueous solution, and 25% more than the concentration point where no precipitate of water insoluble surfactant and/or phase separation is visible in the aqueous solution.

In a preferred embodiment the water insoluble surfactant is a nonionic surfactant and/or anionic surfactant, preferably a nonionic surfactant. Examples of suitable surfactants and surfactant ratios can be found in “Surfactants”-section “Aqueous Surfactant System”-section above.

According to this aspect of the invention the point where surfactant precipitate and/or phase separation is visible may be determined at a temperature between 5 and 45° C. at pH 7 or pH 9, such as between 40 and 45° C. at pH 7 or pH 9. In case of surfactant systems having a different in-use conditions the point where surfactant precipitate and/or phase separation is visible may be determined at a temperature between 60 and 70° C. at pH 7 or pH 9, preferably 65° C., more preferably 67° C., more preferably 68° C., even more preferably 69° C., especially 70° C. at pH 7 or pH 9.

In a preferred embodiment concentration of water insoluble surfactant is in the range between 20%, preferably 10%, especially 5%, less than the concentration point where no surfactant precipitate and/or phase separation is visible in the aqueous solution, and 20%, preferably 10%, especially 5%, more than the concentration point where no surfactant precipitate and/or phase separation is visible in the aqueous solution.

In a more preferred embodiment concentration of water insoluble surfactant is in the range between 25%, preferably 20%, more preferably 10%, especially 5%, less than the concentration point where no surfactant precipitate and/or phase separation is visible in the aqueous solution and the concentration point where no surfactant precipitate and/or phase separation is visible in the aqueous solution.

### Use of an Aqueous Surfactant System or Cleaning Composition of the Invention

In this aspect the invention relates to the use of an aqueous surfactant system or cleaning composition of the invention for cleaning surfaces, preferably hard and/or soft surfaces.

Hard surfaces include concrete, metal, glass, ceramic, plastic, linoleum and similar surfaces. Hard surfaces are found in toilets, shower stalls, bathtubs, sinks, countertops, walls, floors and also include road surfaces.

Soft surfaces include carpets, furniture, upholstery fabric, slippers, clothing and other fibrous materials.

The surface may in one embodiment be oil or grease stained surfaces.

### Method of Increasing Cleaning Efficacy

In a final aspect the invention relates to a method of increasing the cleaning efficacy of a surfactant system or cleaning composition comprising one or more anionic surfactants and one or more nonionic surfactants, comprising the step of reducing the water solubility of the surfactant system by

a) introducing salt into the surfactant system or cleaning composition, and/or

b) introducing a water insoluble surfactant into the surfactant system or cleaning composition.

As also mentioned above, the gist of the invention is to maximize the cleaning efficacy of a surfactant system or cleaning system by reducing or minimizing the size of the surfactants typically used in surfactant systems and reducing or minimizing the water solubility of the surfactant system. Reducing or minimizing the size of the surfactant molecules decrease the time required for diffusion from the solution to the appropriate interfaces, thereby increasing cleaning performance.

Reducing or minimizing the solubility of the surfactant system in water increases the adsorption efficiency of the surfactant system at the appropriate interfaces, thereby increasing cleaning performance.

The insolubility of the surfactant system or cleaning composition is defined by the visual appearance of a precipitate (at least a homogenous haziness or turbidity) or a liquid-liquid phase separation.

The salt and surfactants may be as mentioned in the “Salts” and “Surfactants”-sections above.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. In the case of conflict, the present disclosure including definitions will control.

Various references are cited herein, the disclosures of which are incorporated by reference in their entireties.

### Materials & Methods

### Surfactants:

Water insoluble nonionic surfactant: Tomadol™ 91-2.5 from Tomah Products is an alcohol ethoxylate with an average carbon length of C9-11 having an average ethoxylation of 2.7.
Water soluble nonionic surfactant: Tomadol™ 91-6 from Tomah Products is an alcohol ethoxylate with an average carbon length of C9-11 having an average ethoxylation of 6.
Neodol 91-6 from Shell is the same chemical as Tomadol 91-6. Note that Tomadol™ 91-6 is equivalent to Neodol™ 91-6. This is the same chemical manufactured by Shell.
Water soluble anionic surfactant: Sodium octyl sulfonate, purchased as BIO-TERGE PAS-8S (a formulation containing 37.8% sodium octyl sulfonate) from Stepan Products, is a water soluble anionic surfactant. An appropriate substitute source of sodium octyl sulfonate would be Witconate NAS-8, from Witco, which is a formulation containing 36.0% sodium octyl sulfonate.

Dodecyl benzene sulfonic acid, purchased as BIO-SOFT S-101 from Stepan Products, when neutralized in aqueous solution with a base such as sodium hydroxide, is a water soluble anionic surfactant.

Kathon CG/ICP is manufactured by Rohm & Haas, and Bronopol (BIOBAN BP-PLUS) is manufactured by DOW.

Nipacide™ BIT 20 is manufactured by Clariant Corporation.

### Enzymes:

Lipex™ 100L: Lipase derived from a strain Thermomyces lanuginosus available from Novozymes A/S.

### EXAMPLES

### Example 1

### Preparation of a Carpet Spot Remover

The following surfactant systems were prepared. In each formulation, the active Sodium Octyl Sulfonate is introduced as BIO-TERGE® PAS-8S (Stepan Company), which is a solution containing 37.8% active Sodium Octyl Sulfonate. In the following examples where Sodium Octyl Sulfonate is used, the quantity of Sodium Octyl Sulfonate is given as percent actives.

A. Anionic Surfactant and Nonionic Surfactant in a Ratio of about 6:1 (Formulation A).

This formulation is a starting formulation to be used as active cleaning base in a carpet spot remover.

| | % By | |
|---|---|---|
| Material | Weight | Function |
| Water | Q.S. | Solvent for all other materials |
| Sodium Octyl | 1.28 | Water soluble anionic surfactant, |
| Sulfonate | | allows powdery residue |
| Tomadol 91-6 | 0.23 | Water soluble nonionic surfactant |
| Isopropyl | 2.50 | Organic solvent to help with water- |
| Alcohol | | insoluble stain removal |
| Kathon | 0.050 | Preservative |
| CG/ICP | | |
| Bronopol | 0.025 | Preservative |
| (BIOBAN ™ | | |
| BP-PLUS) | | |
| Citric Acid | 0.25 | Provide buffering pH 6-7 |
| Caustic Soda | 0.30 | pH adjustment of citric acid to pH 6-7 |

Formulation A was clear and colorless with no visual precipitate or liquid phase separation.

Formulation A was also stable at temperatures between 5° C. to 45° C.

### B. 50/50 Tomadol 91-6/Tomadol 91-2.5, 1.50% Total Surfactant (Formulation B)

| Material | % By Weight |
|---|---|
| Water | Q.S. |
| Sodium Octyl Sulfonate | 1.28 |
| Tomadol 91-6 | 0.11 |
| Tomadol 91-2.5 | 0.11 |
| Isopropyl Alcohol | 2.50 |
| Kathon CG/ICP | 0.050 |
| Bronopol (BIOBAN ™ BP-PLUS) | 0.025 |
| Citric Acid | 0.25 |
| Caustic Soda | 0.30 |

Formulation B was clear and colorless with no visual precipitate or liquid phase separation. Formulation B was also stable at temperatures between 5° C. to 45° C.

The capability of Formulation B to remove motor oil stains on carpet was investigated.

Formulation B was found to be better at solubilizing and removing used motor oil stains than Formulation A. However, the oil stain seemed to be “smeared” around as well as being removed.

The amount of Tomadol 91-2.5 relative to Tomadol 91-6 is increased in Formulation C below.

### C. 30/70 Tomadol 91-6/Tomadol 91-2.5, 1.51% Total Surfactant (Formulation C)

| Material | % By Weight |
|---|---|
| Water | Q.S. |
| Sodium Octyl Sulfonate | 1.28 |
| Tomadol 91-6 | 0.07 |
| Tomadol 91-2.5 | 0.16 |
| Isopropyl Alcohol | 2.50 |
| Kathon CG/ICP | 0.050 |
| Bronopol (BIOBAN ™ BP-PLUS) | 0.025 |
| Citric Acid | 0.25 |
| Caustic Soda | 0.30 |

Formulation C was clear and colorless with no visual precipitate or liquid phase separation.

Formulation C was found to be capable of removing used motor oil stains from carpet without smearing the oil around.

When a Formulation C1 with Tomadol 91-6/Tomadol 91-2.5 in a ratio of 20/80 was prepared, it was turbid and not clear. Consequently, Formulation C seems to be close to an optimal formulation (with resolution 30/70-20/80).

Formulation C was stable at a temperature between 5° C. to 45° C.

### D. No Isopropyl Alcohol, 2.30% Total Surfactant Formulation D)

| Material | % By Weight |
|---|---|
| Water | Q.S. |
| Sodium Octyl Sulfonate | 1.96 |
| Tomadol 91-6 | 0.10 |
| Tomadol 91-2.5 | 0.24 |
| Kathon CG/ICP | 0.050 |
| Bronopol (BIOBAN ™ BP-PLUS) | 0.025 |
| Caustic Acid | 0.25 |
| Caustic Soda | 0.30 |

Formulation D was clear and colorless with no visual precipitate or liquid phase separation.

Formulation D was also stable at temperatures between 5° C. to 45° C.

### D1. 0/100 Tomadol 91-6/Tomadol 91-2.5, 2.31% Total Surfactant (Formulation D1)

| Material | % By Weight |
|---|---|
| Water | Q.S. |
| Sodium Octyl Sulfonate | 1.96 |
| Tomadol 91-2.5 | 0.35 |
| Kathon CG/ICP | 0.050 |
| Bronopol (BIOBAN ™ BP-PLUS) | 0.025 |
| Citric Acid | 0.25 |
| Caustic Soda | 0.30 |

Formulation D1 was clear and colorless with no visual precipitate or liquid phase separation. However, it was slightly hazy before the final addition of citric acid and caustic soda. Formulation D1 seems to have attained the minimum solubility of the surfactant system.

Formulation D1 was stable at temperatures from 5° C. to 45° C.

### E. 20/80 Tomadol 91-6/Tomadol 91-2.5, 1.60% Total Surfactant (Formulation E)

| Material | % By Weight |
|---|---|
| Water | Q.S. |
| Sodium Octyl Sulfonate | 1.36 |
| Tomadol 91-6 | 0.05 |
| Tomadol 91-2.5 | 0.19 |
| Kathon CG/ICP | 0.050 |
| Bronopol (BIOBAN ™ BP-PLUS) | 0.025 |
| Citric Acid | 0.25 |
| Caustic Soda | 0.30 |

Formulation E was hazy. It was not certain whether a precipitate, or phase separation, would eventually occur.

### F. 20/80 Tomadol 91-6/Tomadol 91-2.5, 1.80% Total Surfactant (Formulation F)

| Material | % By Weight |
|---|---|
| Water | Q.S. |
| Sodium Octyl Sulfonate | 1.53 |
| Tomadol 91-6 | 0.054 |
| Tomadol 91-2.5 | 0.216 |
| Kathon CG/ICP | 0.050 |
| Bronopol (BIOBAN ™ BP-PLUS) | 0.025 |
| Citric Acid | 0.25 |
| Caustic Soda | 0.30 |

Formulation F was hazy, although less hazy than Formulation E. It was not certain whether a precipitate, or phase separation, would eventually occur.

### G. 20/30 Tomadol 91-6/Tomadol 91-2.5, 1.90% Total Surfactant (Formulation G)

| Material | % By Weight |
|---|---|
| Water | Q.S. |
| Sodium Octyl Sulfonate | 1.62 |
| Tomadol 91-6 | 0.057 |
| Tomadol 91-2.5 | 0.228 |
| Kathon CG/ICP | 0.050 |
| Bronopol (BIOBAN ™ BP-PLUS) | 0.025 |
| Citric Acid | 0.25 |
| Caustic Soda | 0.30 |

Formulation G was hazy, although less hazy than Formulation F. It was not certain whether a precipitate, or phase separation, would eventually occur.

### H. 20/80 Tomadol 91-6/Tomadol 91-2.5, 2.00% Total Surfactant (Formulation H)

| Material | % By Weight |
|---|---|
| Water | Q.S. |
| Sodium Octyl Sulfonate | 1.70 |
| Tomadol 91-6 | 0.06 |
| Tomadol 91-2.5 | 0.24 |
| Kathon CG/ICP | 0.050 |
| Bronopol (BIOBAN ™ BP-PLUS) | 0.025 |
| Citric Acid | 0.25 |
| Caustic Soda | 0.30 |

Formulation H was clear and colorless with no visual precipitate or liquid phase separation. However, it was very slightly hazy before the final addition of citric acid and caustic soda. Consequently, Formulation H seems to have attained the minimum solubility of the surfactant system. Furthermore, this formulation is also stable from 5° C. to 45° C.

Formulations C, D1 and H show that the solubility is not related to the cloud point. These formulations had minimal solubility at room temperature and are phase stable from at least 5° C. to 45° C. In this example, the stability and cleaning efficacy seem to be related to the surfactant system solubilizing the water insoluble Tomadol 91-2.5.

A cleaning performance study (Technical Bulletin CRI TM 110, The Caret and Rug Institute, Dalton, Ga.) was done by staining carpet, untreated with stain blockers, with mustard, ketchup, coffee, grape juice, permanent ink, used motor oil, soil, and chocolate syrup. The stains were allowed to set for at least 24 hours and then the stains were treated by application of various formulations and lightly rubbing and blotting. The treated carpet was allowed to dry for at least 12 hours before evaluation of stain removal. Stain removal was evaluated visually. In this cleaning study, Formulation D1 and Formulation H performed about equal and slightly better than Formulation C, particularly on water-insoluble stains like permanent ink and used motor oil. It may be because Formulation C had the lowest total surfactant content. The conclusion is that cleaning performance can be improved by reducing or minimizing the solubility of the surfactant system and that it is not necessary to include an organic solvent like isopropyl alcohol to attain good cleaning efficacy/performance.

### Example 2

### Caret Extraction Cleaner

An aqueous cleaning composition for use in carpet extraction cleaning was prepared as described below. The cleaning compositions illustrate products that the consumer purchases and dilutes in water by adding 2 ounces (56.7 grams) to the filling tank and filling with hot water to make a total of one gallon (3.79 liters).

The objective is to minimize the solubility of the surfactant system for in-use cleaning compositions at hot water temperatures in the range from 60-70° C. Typically, the highest in-use temperature would be about 150° F. (65.6° C.). The non-diluted original surfactant system or original cleaning composition should be phase stabile from 5° C. to 45° C.

Five original cleaning composition formulations were prepared, and the compositions, as weight/weight percentages, are given in Table 1 below. The ratio of Tomadol 91-6 to Tomadol 91-2.5 is also given as a percentage ratio of the total content of Tomadol 91-6 and Tomadol 91-2.5. Note that for all of these formulations, the only change is the relative amounts of Tomadol 91-6 and Tomadol 91-2.5. These in-use cleaning solution were prepared by adding 6.25 g of the original cleaning formulations to a bottle, and bringing the total mass to 400 g with tap water. These in-use cleaning solutions were then placed in a hot water bath, set at 69° C., to establish the solubility of the surfactant system. The results are given in Table 2 below. Note that for completeness, additional temperatures to 70° C. were investigated.

The tables show the optimized in-use cleaning composition for a temperature of 69° C., which is slightly above the maximum temperature expected for use in extraction cleaning. For example, if the temperature for extraction cleaning is 60° C., then either KNKE3-33 or KNKE3-35 would be the appropriate cleaning composition to use.

Regarding the required temperature stability of the cleaning composition formulations, all of the formulations prepared were found to be stable from 5° C. to 45° C. Therefore, KNKE3-32 would be a suitable cleaning composition for carpet extraction cleaning when the maximum temperature of the hot water is 69° C.

TABLE 1
Original cleaning composition formulations. The ratio of Tomadol
91-6 to Tomadol 91-2.5 is also given as a percentage ratio of
the total content of Tomadol 91-6 and Tomadol 91-2.5.

| | KNKE3-29 | KNKE3-31 | KNKE3-32 | KNKE3-33 | KNKE3-35 |
|---|---|---|---|---|---|
| | 50/50 | 0/100 | 25/75 | 15/85 | 20/80 |
| Water | Q.S. | Q.S. | Q.S. | Q.S. | Q.S. |
| Sodium Octyl | 2.34 | 2.34 | 2.34 | 2.34 | 2.34 |
| Sulfonate | | | | | |
| Tomadol 91-6 | 0.96 | 0.00 | 0.48 | 0.29 | 0.38 |
| Tomadol 91-2.5 | 0.96 | 1.91 | 1.43 | 1.63 | 1.53 |
| Kathon | 0.050 | 0.050 | 0.050 | 0.050 | 0.050 |
| Bronopol | 0.025 | 0.025 | 0.025 | 0.025 | 0.025 |
| Citric Acid | 4.25 | 4.25 | 4.25 | 4.25 | 4.25 |
| Caustic Soda | 4.90 | 4.90 | 4.90 | 4.90 | 4.90 |

TABLE 2
Solubility of in-use cleaning compositions prepared from the respective
original cleaning composition formulations given in Table 1. A clear
solution is designated by “◯”, and a turbid solution, or
one with noticeable haze is designated by “X”.

| | 60° C. | 65° C. | 67° C. | 68° C. | 69° C. | 70° C. |
|---|---|---|---|---|---|---|
| KNKE3-29DIL | ◯ | ◯ | ◯ | ◯ | ◯ | ◯ |
| KNKE3-31DIL | X | X | X | X | X | X |
| KNKE3-32DIL | ◯ | ◯ | ◯ | ◯ | ◯ | X |
| KNKE3-33DIL | ◯ | X | X | X | X | X |
| KNKE3-35DIL | ◯ | X | X | X | X | X |

### Examples 3

### Preparation of Concrete Cleaner (3× Concentrate) with Salt

### 1. Concrete Cleaner 3× Concentrate

A concrete cleaner, KNKE 59, was prepared so that the concentration of surfactants was 3-times higher that the in-use concentration. The formulation is given below in Table 3. This formulation had a pH of 8.92, and was found to be stable from freeze-thaw to at least 45° C. The strategy was to minimize the solubility of the 1:2 dilutions so that the performance of the 1:2 dilutions was maximized.

In Table 3 below, Dodecyl Benzene Sulfonic Acid is given as the actual quantity of BIO-SOFT® S-101 (Stepan Company) added, which is 96% active. It was neutralized, or converted to the sodium salt (anionic form), by the addition of sodium hydroxide.

TABLE 3
Concrete Cleaner 3X Concentrate, KNKE 59

| | % wt./wt. |
|---|---|
| Dodecyl Benzene Sulfonic Acid | 5.14 |
| Tomadol 91-6 | 44.44 |
| EDTA (40%) | 2.40 |
| Urea | 2.40 |
| Nipacide BIT 20 | 0.30 |
| Sodium Bicarbonate | 0.45 |
| Sodium Carbonate | 0.05 |
| Water | Q.S. |

### 2. Dilutions of Concrete Cleaner 3× Concentrate

Three dilutions of Concrete Cleaner 3× Concentrate KNKE 59 were made, and are listed in Table 4 below. Note also that sodium bicarbonate and sodium carbonate were added to two of the dilutions (Dilution A and Dilution B), accounting for the different quantities of water used for dilution of KNKE 59.

TABLE 4
Dilutions of Concrete Cleaner 3X Concentrate, KNKE 59.

| | Dilution A | Dilution B | Dilution C |
|---|---|---|---|
| | (% wt/wt) | (% wt/wt) | (% wt/wt) |
| KNKE 59 | 33.3 | 33.3 | 33.3 |
| Water | 64.8 | 62.6 | 66.7 |
| Sodium Bicarbonate | 1.55 | 3.25 | 0 |
| Sodium Carbonate | 0.28 | 0.58 | 0 |

The total salt content (sodium bicarbonate and sodium carbonate), the cloud point, and the pH values, are given in Table 5 below. Here, the cloud point was defined as the temperature where the formulation became turbid. Below the cloud point, the formulation is clear.

TABLE 5
Physical Characteristics of Dilution A, Dilution B, and
Dilution C. NaHCO₃ (Sodium bicarbonate) and Na₂CO₃ (Sodium
carbonate). The cloud point was measured on the actual
cleaning formulation given in the first column.

| | Total Salt | | | | |
|---|---|---|---|---|---|
| | (NaHCO₃ + | | | | |
| | Na₂CO₃), | NaHCO₃ | Na₂CO₃ | | Cloud Point |
| | % wt./wt. | % wt./wt | % wt./wt. | pH | (° C.) |
| Dilution A | 2.00 | 1.70 | 0.30 | 8.86 | 43 |
| Dilution B | 4.00 | 3.40 | 0.60 | 8.79 | 32 |
| Dilution C | 0.17 | 0.15 | 0.02 | 8.88 | >60 |

### 3. Cleaning Performance Study

A cleaning performance study was done. Backs of tiles were sanded so that they were smooth, coated with used motor oil, baked for about 30 minutes in a 105° C. oven, and cooled to room temperature. Two drops (0.05 g) of the concrete cleaner samples were placed on one half of the stained tile backs, and two drops of a reference standard KNKE 27 (0.05 g) were placed on the other half. The drops were allowed to stand for 10 minutes, and then they were scrubbed with a wet toothbrush for 10 seconds. The tile backs were allowed to dry for at least 30 minutes, and the color intensity (reflectance) was read on a reflectance spectrophotometer (Color-Eye 7000A, Gretagmacbeth). The cleaning performance Ax was calculated based on ΔE on the Lab color scale (note that this is not a laboratory (lab) scale, but that L, a, and b are different parameters). A value for Ax of 1.0 would represent complete stain removal, while a value of 0.0 would represent no stain removal.

Ax=[ΔEstained−ΔEclean]/[ΔEstained]

Here, ΔEstained is the value of ΔE for the portion of the tile back that was not cleaned, and ΔEclean is the value of ΔE that was cleaned using a concrete cleaner. The reference value for calculations of each ΔE was a tile back that was not stained with oil, representing a clean tile back.

Ax values are calculated for the various concrete cleaner samples, where x represents Dilution A, Dilution B, Dilution C, or KNKE 27. All values of Ax were normalized to KNKE 27, which is assigned a value of 1.0. Therefore, a value of Ax less than 1.0 means that the cleaning efficacy is less than KNKE 27, a value of Ax greater than 1.0 means that the cleaning efficacy is greater than KNKE 27, and a value of Ax equal to 1.0 means that the cleaning efficacy is equal to KNKE 27. The standard deviations were also recalculated to correspond to the normalized Ax values. The cleaning performance study results are given in Table 6 below.

Note that there were two reasons for using a reference standard. The first was that it should account for any differences in the staining procedure from tile to tile such as darkness and thickness of the applied coatings of used motor oil. In other words, the reference standard provides a constant in an experiment where the staining procedure does not provide a constant darkness or thickness of coating. The second was that it provides a standard with respect to performance. The reference standard, KNKE 27, is a non-diluted form of the concrete cleaner, and was found to give an acceptable cleaning performance.

The composition of KNKE 27 is given in Table 6 below.

TABLE 6
Performance results. Duplicate runs, or measurements on two
different tile backs were made, and the results were normalized
to the average of KNKE 27 (assigned a value of 1.0).

| | Average Normalized Ax | Standard Deviation |
|---|---|---|
| Dilution C (0.17% Salt) | 0.782 | 0.022 |
| Dilution A (2.0% Salt) | 0.887 | 0.073 |
| Dilution B (4.0% Salt) | 0.959 | 0.105 |

The results shown in Table 6 above demonstrate that there is a significant effect of sat content on cleaning performance. A comparison to the pH values given in Table 5 shows that the cleaning performance is not related to pH, and must therefore be related to salt and solubility of the surfactant. An important distinction must be made between the cleaning performance here and the cleaning performance expected at the cloud point of a surfactant system. It is well known that the cleaning performance increases greatly at the cloud point of the surfactant system. However, the cleaning performance measurements were done at 22° C., well below the cloud point of the surfactant systems (Table 5). Consequently, the observed cleaning enhancement with increasing salt content is not due to the cloud point phenomena. It also is not expected based on an increase in the saturation adsorption of surfactant at an interface (which would create a lower interfacial tension and increase cleaning performance) since it has been shown that this saturation adsorption increases only slightly upon addition of a neutral electrolyte. In summary, it is surprising that cleaning performance is increased by the addition of salt in a surfactant system where only 10% of the total surfactant content is anionic and that the temperature of the cleaning performance studies are well below the cloud point of the surfactant system.

To give a practical meaning to the above results, a visual evaluation was necessary. Visually, Dilution C did not give an acceptable cleaning performance, while the cleaning performance of Dilution A and Dilution B were acceptable.

In the Table 7 below, Dodecyl Benzene Sulfonic Acid is given as the actual quantity of BIO-SOFT® S-101 (Stepan Company) added, which is 96% active. It was neutralized, or converted to the sodium salt, by the addition of sodium hydroxide.

TABLE 7
Composition of KNKE 27. KNKE 27 has a pH of 9.16,
and a cloud point of 45° C. −46° C.

| | % wt./wt. |
|---|---|
| Dodecyl Benzene Sulfonic Acid | 3.43 |
| Neodol 91-6 | 13.17 |
| EDTA (40%) | 0.80 |
| Urea | 0.80 |
| Nipacide | 0.10 |
| Sodium Bicarbonate | 1.70 |
| Sodium Carbonate | 0.30 |
| Water | Q.S. |

### Example 4

### Floor cleaners

This example shows the improved cleaning performance of a floor cleaner that contains two water-soluble nonionic surfactants and one water-insoluble nonionic surfactant in comparison to an otherwise identical floor cleaner that contains just one water-soluble nonionic surfactant and one water-insoluble nonionic surfactant. The final surfactant composition for both floor cleaners was determined by minimizing the water solubility in accordance to the methods outlined in this invention.

### Floor Cleaner 1

A floor cleaner containing one water-soluble anionic surfactant, two water-soluble nonionic surfactants and one water-insoluble nonionic surfactant was prepared according to minimizing the water solubility as disclosed in this document. The final composition is given in Table 8.

TABLE 8

| Component | Percent by Weight |
|---|---|
| EDTA, 40% Solution | 0.800 |
| Nipacide | 0.060 |
| Tomadol 91-8 | 1.324 |
| Tomadol 91-6 | 1.565 |
| Tomadol 91-2.5 | 1.445 |
| Steol CS-330 | 1.718 |
| LIPEX ™ 100L | 5.000 |
| Water | 80.088 |

Tomadol 91-6 and Tomadol 91-8 are water-soluble nonionic surfactants.

Tomadol 91-2.5 is a water-insoluble nonionic surfactant.

Steol CS-330 is a solution containing about 30% alkyl ether sulfate, ethoxylated to an average of 3 moles, a water-soluble anionic surfactant.

The final pH was 9.02.

### Floor Cleaner 2

A floor cleaner containing one water-soluble anionic surfactant, one water-soluble nonionic surfactant and one water-insoluble nonionic surfactant was prepared according to minimizing the water solubility as disclosed in this document. The final composition is given in Table 9.

TABLE 9

| Component | Percent by Weight |
|---|---|
| EDTA, 40% Solution | 0.800 |
| Nipacide | 0.060 |
| Tomadol 91-6 | 3.370 |
| Tomadol 91-2.5 | 0.960 |
| Steol CS-330 | 1.718 |
| Lipex 100L | 5.000 |
| Water | 80.092 |

The final pH was 9.05.

### Cleaning Results:

The following experiment was performed to evaluate the ability of the above floor cleaners to remove oil and dirt.

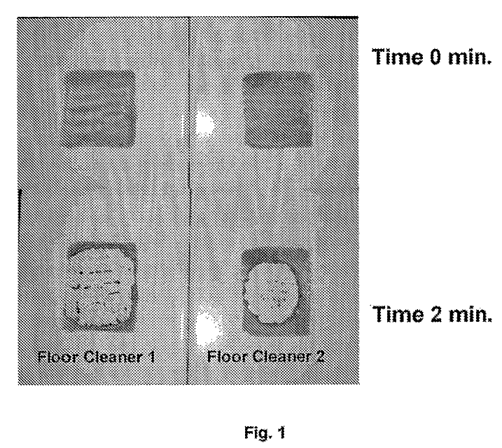

Five drops (0.15 grams) of a mixture containing 0.5% carbon black and 99.5% corn oil were placed on a porcelain tile. The resulting puddle was spread into a square the width of two hockey sticks typically used for plating bacteria. Then, a drop of 0.5 grams of the cleaning solution was placed in the center of the square, and the drop was allowed to spread for two minutes without any external influence. This test demonstrates the ability of the cleaner to spontaneously displace oil and dirt from the surface, and eliminates any influence due to mechanical action, and the results are shown in FIG. 1. Also, the presence of lipase has no effect on cleaning during the time duration of the test, which is too short to show any lipase activity.

These results clearly show the enhanced ability of Floor Cleaner 1 spontaneously displace oil and dirt from the surface in comparison to Floor Cleaner 2. This shows that formulations prepared to have minimal solubility do not necessarily have to have identical cleaning performance. It is likely that Floor Cleaner 1 has an enhanced ability to spontaneously displace oil and dirt from the surface due to a lower surface tension because it contains more of the water-insoluble surfactant Tomadol-2.5. In fact, when visually observed on parafilm, a 20 microliter drop of Formulation 1 is flatter than a 20 microliter drop of Formulation 2. The lower surface tension allows the liquid to spread out more rapidly and thoroughly over the surface and displace oil and dirt. Floor Cleaner 1 contains more Tomadol 91-2.6 due to the presence of Tomadol 91-8, which has a higher water solubility than Tomadol 91-6.

### Example 5

### Compositions of the Invention

Composition 1: This is a general floor cleaner with the specific composition of a product. For actual use, this product is to be diluted 2-4 oz. per gallon with water.

| Component | Percent by Weight |
|---|---|
| EDTA, 40% Solution | 0.800 |
| Nipacide | 0.060 |
| Tomadol 91-8 | 1.324 |
| Tomadol 91-6 | 1.565 |
| Tomadol 91-2.5 | 1.445 |
| Steol CS-330 | 1.718 |
| Water | 93.088 |

Steol CS-330 is a solution containing approximately 30 percent of an anionic surfactant, an alcohol ether sulfate ethoxylated to an average of 3 moles (Stepan), Tomadol 91-8 and Tomadol 91-6 are water-soluble nonionic surfactants (Tomah) and Tomadol 91-2.5 is a water-insoluble nonionic surfactant.

Composition 2: This is a floor cleaner with enzymes, specifically a lipase, designed for kitchen floors for enhanced grease and fat removal. This is the specific composition of a product. For actual use, this product is to be diluted 2 oz. per gallon with water, preferably hot water.

| Component | Percent by Weight |
|---|---|
| EDTA, 40% Solution | 0.800 |
| Nipacide | 0.060 |
| Tomadol 91-8 | 1.324 |
| Tomadol 91-6 | 1.565 |
| Tomadol 91-2.5 | 1.445 |
| Steol CS-330 | 1.718 |
| Lipex 100L | 2.500 |
| Water | 90.588 |

Composition 3: This is a general composition giving a range of components with respect to Composition 1 above.

| Component | Percent by Weight |
|---|---|
| EDTA, 40% Solution | 0-10 |
| Nipacide | 0-1 |
| Tomadol 91-8 | 0.1-50 |
| Tomadol 91-6 | 0.1-50 |
| Tomadol 91-2.5 | 0.1-12 |
| Steol CS-330 | 0-25 |
| Water | 50-97 |

Composition 4: This is a generic composition of Composition 3 above. Note that the anionic surfactant is now given in terms of active surfactant (Steol CS-330 was approximately 30% active), and not in terms of a specific product like Steol CS-330. The Water-Soluble Anionic Surfactant can be any listed previously in this document.

| Component | Percent by Weight |
|---|---|
| Chelate | 0-10 |
| Preservative | 0-1 |
| Water-Soluble Nonionic Surfactant 1 | 0.1-50 |
| Water-Soluble Nonionic Surfactant 2 | 0.1-50 |
| Water-Insoluble Nonionic Surfactant | 0.1-30 |
| Water-Soluble Anionic Surfactant | 0-40 |
| Water | 50-97 |

Composition 5: This is a general composition giving a range of components with respect to Composition 2 above.

| Component | Percent by Weight |
|---|---|
| EDTA, 40% Solution | 0-10 |
| Nipacide | 0-1 |
| Tomadol 91-8 | 0.1-50 |
| Tomadol 91-6 | 0.1-50 |
| Tomadol 91-2.5 | 0.1-12 |
| Steol CS-330 | 0-25 |
| Lipex 100L | 0-25 |
| Water | 50-97 |

Composition 6: This is a general composition of Composition 5 above. Note that now the lipase is given in terms of percent of active material by weight, as opposed to a total enzyme solution (like Lipase 100L or Lipolase 100L for example) percent weight. This does not limit the source of lipase to be a solution, for the lipase could be incorporated as a dry powder. Different types of enzymes other than lipase may be incorporated, e.g., protease or alpha-amylase enzymes, may be included either separately or in combination with or without lipase enzymes.

| Component | Percent by Weight |
|---|---|
| Chelate | 0-10 |
| Preservative | 0-1 |
| Water-Soluble Nonionic Surfactant 1 | 0.1-50 |
| Water-Soluble Nonionic Surfactant 2 | 0.1-50 |
| Water-Insoluble Nonionic Surfactant | 0.1-30 |
| Water-Soluble Anionic Surfactant | 0-40 |
| Lipase Enzymes | 0-10 |
| Water | 50-97 |

### SUMMARY PARAGRAPHS

The present invention is defined in the claims and accompanying description. For convenience, other aspects of the present invention are presented herein by way of numbered paragraphs.

1. An aqueous surfactant system comprising one or more anionic surfactant and one or more nonionic surfactant.
2. The surfactant system of paragraph 1, wherein the ratio between anionic surfactant and nonionic surfactant is in the range from 10:1 to 1:10, preferably 10:1 to 1:1, more preferably from 8:1 to 1:1, such as 6:1 to 1:1.
3. The surfactant system of paragraph 1 or 2, wherein the surfactant system contains a water soluble anionic surfactant and/or a water insoluble anionic surfactant.
4. The surfactant system of paragraph 1 or 2, wherein the surfactant system contains a water insoluble nonionic surfactant and/or water soluble nonionic surfactant.
5. The surfactant system of any of paragraphs 1-4, wherein the ratio between anionic surfactant and water insoluble nonionic surfactant is in the range from 10:1 to 1:10, preferably from 10:1 to 1:1, more preferably from 8:1 to 1:1, more preferably from 4:1 to 1:1.
6. The surfactant system of any of paragraphs 1-5, wherein the ratio between the water soluble nonionic surfactant and water insoluble nonionic surfactant is in the range from 10:1 to 1:10, preferably from 1:10 to 1:1, more preferably from 1:6 to 1:1.
7. The surfactant system of any of paragraphs 1-6, wherein the ratio between anionic surfactant and total amount of nonionic surfactant is 10:1 to 1:10, preferably 10:1 to 1:1, more preferably 6:1 to 1:1.
8. The surfactant system of any of paragraphs 1-7, comprising two or more nonionic surfactants and an anionic surfactant.
9. The surfactant system of any of paragraphs 1-8, comprising one of the nonionic surfactants is a water insoluble surfactant.
10. The surfactant system of any of paragraphs 1-9, comprising two or more water-soluble nonionic surfactants and one water-insoluble nonionic surfactant.
11. The surfactant system of any of paragraphs 1-10, comprising one water-soluble anionic surfactant, one water-soluble nonionic surfactant and one water-insoluble nonionic surfactant.
12. An aqueous surfactant system comprising one or more anionic surfactants and one or more salts, wherein one or more salts are present in an amount from 0.5 to 10 wt. %.
13. The surfactant system of paragraph 12, wherein the anionic surfactant is a water soluble anionic surfactants and/or a water insoluble anionic surfactant.
14. The surfactant system of paragraph 11 or 12, further comprising one or more nonionic surfactants.
15. The surfactant system of any of paragraphs 11-14, wherein the surfactant system comprises a water soluble nonionic surfactant and/or water insoluble nonionic surfactant, preferably water soluble.
16. The surfactant system of any of paragraphs 11-15, comprising water soluble anionic surfactant and water soluble nonionic surfactants in a ratio between 1:20 and 2:1, preferably 1:12 to 1:1, especially 1:10 to 1:5.
17. The surfactant system of any of paragraphs 8-12, wherein the ratio between the anionic surfactants and the nonionic surfactants is between 1:20 to 2:1, preferably 1:12 to 1:1, especially 1:10 to 1:5.
18. The surfactant system of any of paragraphs 11-17, wherein the salt is selected from the group consisting of alkali metal salts of nitrates, acetates, chlorides, bromides, iodides, sulfates, hydroxides, carbonates, hydrogen carbonates, phosphates, sulfides, and sulfites; ammonium salts of nitrates, acetates, chlorides, bromides, iodides, sulfates, hydroxides, carbonates, hydrogen carbonates (also called bicarbonates), phosphates, sulfides, and sulfites; alkaline earth metal salts of nitrates, chlorides, bromides, iodides, sulfates, sulfides, and hydrogen carbonates; manganese, iron, copper, and zinc salts of nitrates, acetates, chlorides, bromides, iodides, and sulfates, citrates and borates, or mixtures thereof.
19. The surfactant system of any of paragraphs 11-18, wherein the salt is a carbonate, in particular sodium carbonate and/or sodium bicarbonate, preferably in a ratio of 1:10 to 10:1.
20. The surfactant system of any of paragraphs 11-19, wherein the total amount of salt is between 0.8 to 8 wt. %, preferably 1-5 wt. %, more preferably around 2 wt. %.
21. The surfactant system of any of paragraphs 11-20, wherein the salt concentration in the surfactant system is in the range between

(a) 25%, preferably 10%, less than the salt concentration point where no surfactant precipitate and/or phase separation is visible in the aqueous solution, and

(b) 25%, preferably 10%, more than the salt concentration point where no surfactant precipitate and/or phase separation is visible in the aqueous solution, or

(c) the salt concentration point where no surfactant precipitate and/or phase separation is visible in the aqueous solution.

22. The surfactant system of any of paragraphs 1-21, wherein the surfactant system is free of visible surfactant precipitate and/or phase separation at temperatures in the range from 5 to 45° C., preferably from 40 to 45° C., determined at pH 7 or pH 9.
23. The surfactant system of any of paragraphs 1-22, wherein the surfactant system is free of visible surfactant precipitate and/or phase separation at a temperatures in the range from 60° C. to 70° C., preferably 60° C., preferably 65° C., more preferably 67° C., even more preferably 68° C., even more preferably 69° C., especially at a temperature of 70° C. determined at pH 7 or pH 9.
24. The surfactant system of any of paragraphs 1-23, comprising a total of 0.01-50 wt. % surfactant, or 0.1-20 wt. % surfactant, or 1-5 wt. % surfactant, or around 2 wt. % surfactant.
25. The surfactant system of any of paragraphs 1-24, wherein the water soluble anionic surfactant is one or more anionic surfactants selected from the group consisting of alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonate, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-N-alkyl taurates, and alkyl carboxylates.
26. The surfactant system of paragraph 25, wherein the alkyl sulfate is a sodium, potassium, ammonium, ethanolamine, or magnesium salt.
27. The surfactant system of paragraph 25 or 26, wherein the alkyl sulfate has a carbon chain length from 6 units to 20 units.
28. The surfactant system of any of paragraphs 25-27, wherein the alkyl sulfate is sodium dodecyl sulfate (sodium lauryl sulfate).
29. The surfactant system of paragraph 25, wherein the sulfated ethoxylate of fatty alcohol is a sodium, potassium, ammonium, ethanolamine, or magnesium salt.
30. The surfactant system of paragraph 29, wherein the sulfated ethoxylate of fatty alcohol has 1 to 6 oxyethylene groups.
31. The surfactant system of paragraph 29 or 30, wherein the sulfated ethoxylate of fatty alcohol has a carbon chain length from 6 units to 20 units.
32. The surfactant system of any of paragraphs 29-31, wherein the sulfated ethoxylate of fatty alcohol is sodium laureth sulfate (sodium lauryl ether sulfate)
33. The surfactant system of paragraph 25, wherein the alkyl sulfonate is a sodium, potassium, ammonium, or magnesium salt.
34. The surfactant system of paragraph 33, wherein the alkyl sulfonate is a linear or branched alkyl sulfonate.
35. The surfactant system of paragraph 33 or 34, wherein the alkyl sulfonate has a carbon chain length from 6 units to 20 units.
36. The surfactant system of any of paragraphs 33-35, wherein the alkyl sulfonate is sodium octyl sulfonate.
37. The surfactant system of paragraph 25, wherein the alkyl benzene sulfonate is a sodium, potassium, ammonium, or magnesium salt.
38. The surfactant system of paragraph 37, wherein the alkyl benzene sulfonate is linear or branched.
39. The surfactant system of paragraph 37 or 38, wherein the alkyl benzene sulfonate has a carbon chain length (attached to benzene ring) from 6 units to 20 units.
40. The surfactant system of any of paragraphs 37-39, wherein the alkyl benzene sulfonate is sodium dodecyl benzene sulfonate.
41. The surfactant system of paragraph 25, wherein the alpha-olefin sulfonate is a sodium, potassium, ammonium, or magnesium salt.
42. The surfactant system of paragraph 41, wherein the alpha-olefin sulfonate has a carbon chain length (attached to benzene ring) from 6 units to 20 units.
43. The surfactant system of paragraph 25, wherein the sulfosuccinate is a sodium, potassium, or ammonium salt.
44. The surfactant system of paragraph 43, wherein the sulfosuccinate has a carbon chain length from 4 units to 16 units.
45. The surfactant system of paragraph 43 or 44, wherein the sulfosuccinate is disodium octyl sulfosuccinate.
46. The surfactant system of paragraph 25, wherein the alkyl diphenyloxide sulfonate is a sodium, potassium, or ammonium salt.
47. The surfactant system of paragraph 46, wherein the alkyl diphenyloxide sulfonate has a carbon chain length from 6 units to 22 units.
48. The surfactant system of paragraph 25, wherein the alkyl naphthalene sulfonate is a sodium, potassium, or ammonium salt.
49. The surfactant system of paragraph 48, wherein the alkyl naphthalene sulfonate has a carbon chain length from 0 units to 10 units.
50. The surfactant system of paragraph 48 or 49, wherein the alkyl naphthalene sulfonate is butylnaphthalenesulfonate, sodium salt.
51. The surfactant system of paragraph 25, wherein the ethoxylated sulfosuccinate is a sodium, potassium, or ammonium salt.
52. The surfactant system of paragraph 51, wherein the ethoxylated sulfosuccinate has a carbon chain length from 6 units to 20 units.
53. The surfactant system of paragraph 51 or 52, wherein the ethoxylated sulfosuccinate has 1 to 6 oxyethylene groups.
54. The surfactant system of any of paragraphs 51-53, wherein the ethoxylated sulfosuccinate is 3 mole ethoxylated sodium lauryl sulfosuccinate.
55. The surfactant system of paragraph 25, wherein the phosphate ester is a sodium, potassium, or ammonium salt.
56. The surfactant system of paragraph 51, wherein the phosphate ester has a carbon chain length from 6 units to 22 units.
57. The surfactant system of paragraph 25, wherein the alkyl carboxylate is a sodium, potassium, or ammonium salt.
58. The surfactant system of paragraph 57, wherein the alkyl carboxylate has a carbon chain length from 6 units to 22 units.
59. The surfactant system of paragraph 57 or 58, wherein the alkyl carboxylate is sodium stearate.
60. The surfactant system of paragraph 25, wherein the N-acyl-n-alkyltaurate is a sodium, potassium, and ammonium, calcium, or magnesium salt.
61. The surfactant system of paragraph 60, wherein the N-acyl-n-alkyltaurate has a carbon chain length from 6 units to 22 units.
62. The surfactant system of paragraph 25, wherein the N-alkyl sarcoside is a sodium, potassium, or ammonium salt.
63. The surfactant system of paragraph 62, wherein the N-alkyl sarcoside has a carbon chain length from 6 units to 22 units.
64. The surfactant system of paragraph 62 or 63, wherein the N-alkyl sarcoside is sodium lauroyl sarcoside.
65. The surfactant system of paragraph 25, wherein the benzene-, toluene-, xylene-, or cumene sulfonate is a sodium salt.
66. The surfactant system of paragraph 25, wherein the lignin sulfonate has a molecular weight of 1000 to 20,000.
67. The surfactant system of any of paragraphs 1-66, wherein the water insoluble nonionic surfactant is glycol ether.
68. The surfactant system of any of paragraphs 1-67, wherein the water insoluble nonionic surfactant is an alcohol ethoxylate.
69. The surfactant system of 68, wherein the water insoluble nonionic surfactant is a linear primary, or secondary or branched alcohol ethoxylate having the formula: RO(CH₂CH₂O)ₙH, wherein R has a chain length of C9 to C16 and n from ranges from 0 to 5.
70. The surfactant system of paragraph 68 or 69, wherein the water insoluble nonionic surfactant is a linear primary, or secondary or branched alcohol ethoxylate having the formula: RO(CH₂CH₂O)ₙH, wherein R has a chain length of C9-11 and n is 2.7.
71. The surfactant system of any of paragraphs 68-70, wherein the water insoluble nonionic surfactant is Tomadol™ 91-2.5 or Bio-Soft™ N91-2.5.
72. The surfactant system of any of paragraphs 68-71, wherein the water soluble nonionic surfactant is a linear primary, or secondary or branched alcohol ethoxylate having the formula: RO(CH₂CH₂O)ₙH, wherein R has a chain length of C9 to C16 and n ranges from 6 to 13.
73. The surfactant system of any of paragraphs 68-72, wherein the water soluble nonionic surfactant is a linear primary, or secondary or branched alcohol ethoxylate having the formula: RO(CH₂CH₂O)ₙH, wherein R has a chain length of C10 and n is 6.
74. The surfactant system of any of paragraphs 68-73, wherein the water soluble nonionic surfactant is Neodol™ 91-6. Tomadol 91-6, or Bio-Soft N23-6.5.
75. The surfactant system of any of paragraphs 1-74, wherein the pH is in the range from 6-11, preferably 8-10, especially around 9.
76. The surfactant system of any of paragraphs 1-75, further containing a buffering system.
77. The surfactant system of any of paragraphs 1-76, wherein the surfactant system is solvent free, preferably free of organic solvents, especially isopropyl alcohol.
78. A method of preparing an aqueous surfactant system or cleaning composition comprising one or more anionic surfactants and one or more nonionic surfactants, comprising the steps of

a) preparing an aqueous solution having a fixed concentration of surfactant, and

b) adding salt until the salt concentration is in the range between
i) 25% less than the concentration point where no surfactant precipitate and/or phase separation is visible in the aqueous solution, and
ii) 25% more than the concentration point where no surfactant precipitate and/or phase separation is visible in the aqueous solution, or
iii) the concentration point where no precipitate of water insoluble surfactant and/or phase separation is visible in the aqueous solution.
   In 79. The method of paragraph 78, wherein the anionic surfactant is a water soluble anionic surfactants and/or a water insoluble anionic surfactant.
   80. The method of paragraph 78 or 79, wherein the nonionic surfactant is water soluble or water insoluble.
   81. The method of any of paragraphs 70-80, wherein the point of no surfactant precipitation and/or phase separation is determined at a temperature in the range from 5 to 45° C. at pH 7 or pH 9, such as from 40 to 45° C. at pH 7 or pH 9.
   82. The method of any of paragraphs 78-81, wherein the point of no surfactant precipitation and/or phase separation is determined at a temperature between 60 and 70° C. at pH 9, preferably 60° C., more preferably 65° C., even more preferably 67° C., even more preferably 68° C., even more preferably 69° C., especially 70° C. at pH 7 or pH 9.
   83. The method of any of paragraphs 78-82, wherein the salt concentration is in the range between

a) 20%, preferably 10%, especially 5%, less than the concentration point where no surfactant precipitate and/or phase separation is visible in the aqueous solution, and

b) 20%, preferably 10%, especially 5%, more than the concentration point where no surfactants precipitate and/or phase separation is visible in the aqueous solution, or

c) the salt concentration point where no surfactant precipitate and/or phase separation is visible in the aqueous solution.

84. The method of any of paragraphs 78-83, wherein the total concentration of surfactant is between 0.5 and 50 wt. %, or between 1 and 20 wt. %, or between 1 and 5 wt. %, or around 2 wt. %.
85. The method of any of paragraphs 78-84, wherein the salt is selected from the group consisting of alkali metal salts of nitrates, acetates, chlorides, bromides, iodides, sulfates, hydroxides, carbonates, hydrogen carbonates, phosphates, sulfides, and sulfites; ammonium salts of nitrates, acetates, chlorides, bromides, iodides, sulfates, hydroxides, carbonates, hydrogen carbonates (also called bicarbonates), phosphates, sulfides, and sulfites; alkaline earth metal salts of nitrates, chlorides, bromides, iodides, sulfates, sulfides, and hydrogen carbonates; manganese, iron, copper, and zinc salts of nitrates, acetates, chlorides, bromides, iodides, and sulfates; citrates and borates, or mixtures thereof.
86. The method of any of paragraphs 78-85, wherein the salt is a carbonate, in particular sodium carbonate and/or sodium bicarbonate, preferably added in a ratio of 1:10 to 10:1.
87. The method of any of paragraphs 78-86, wherein the nonionic surfactant is a water soluble nonionic surfactant, preferably an alcohol ethoxylate.
88. The method of paragraph 87, wherein the water soluble nonionic surfactant is linear primary, or secondary or branched alcohol ethoxylate having the formula: RO(CH₂CH₂O)ₙH, wherein R has a chain length of C9 to C16 and n ranges from 6 to 13.
89. The method of paragraph 87, wherein the water soluble nonionic surfactant is linear primary, or secondary or branched alcohol ethoxylate having the formula: RO(CH₂CH₂O)ₙH, wherein R has a chain length of C10 and n is 6.
90. The method of paragraph 87, wherein the water soluble nonionic surfactant is Neodol™ 91-6, Tomadol 91-6, or Bio-Soft N23-6.5.
91. The method of any of paragraphs 78-90, wherein the water insoluble nonionic surfactant is glycol ether.
92. The method of any of paragraphs 78-90, wherein the nonionic surfactant is a water insoluble nonionic surfactant, preferably an alcohol ethoxylate.
93. The method of paragraph 92, wherein the water insoluble nonionic surfactant is linear primary, or secondary or branched alcohol ethoxylate having the formula: RO(CH₂CH₂O)ₙH, wherein R has a chain length of C9 to C16 and n ranges from 0 to 5.
94. The method of paragraph 92, wherein the water insoluble nonionic surfactant is linear primary, or secondary or branched alcohol ethoxylate having the formula: RO(CH₂CH₂O)ₙH, wherein R has a chain length of C9-11 and n is 2.7.
95. The method of paragraph 92, wherein the water insoluble nonionic surfactant is Tomadol™ 91-2.5 or Bio-Soft N91-2.5.
96. The method of any of paragraphs 78-95, wherein the anionic surfactant is a water soluble or water insoluble surfactant.
97. The method of paragraph 96, wherein the water soluble anionic surfactant is one or more anionic surfactant selected from the group consisting of alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonate, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-n-alkyltaurates, and alkyl carboxylates.
98. An aqueous cleaning composition comprising a surfactant system of any of paragraphs 1-77 or prepared according to any of paragraphs 78-97.
99. The cleaning composition of paragraph 98, further comprising bacteria spores or enzymes.
100. The cleaning composition of paragraph 99, wherein the bacteria spores is of the genus Bacillus.
101. The cleaning composition of any of paragraphs 98-100, wherein the enzyme is selected from the group consisting of a amylase, cellulase, lipase, and protease, or mixtures thereof.
102. The cleaning composition of any of paragraphs 98-101, wherein the cleaning composition is solvent free, preferably free of organic solvents, especially isopropyl alcohol.
103. Use of an aqueous surfactant system of any of paragraphs 1-77 or an aqueous cleaning composition of any of paragraphs 98-102 for cleaning hard or soft surfaces.
104. The use of paragraph 103, wherein the soft surface is a carpet.
105. The use of paragraph 103, wherein the hard surface is floor or concrete.
106. The use of any of paragraphs 103-105, wherein the surface is an oil/grease stained surface.
107. A method of preparing an aqueous surfactant system or cleaning composition comprising one or more anionic surfactants and one or more nonionic surfactants, comprising the steps of

a) preparing an aqueous solution having a fixed concentration of one or more water soluble anionic surfactant and/or one or more water soluble nonionic surfactant, and

b) adding one or more water insoluble surfactants until the concentration of water insoluble surfactant is in the range between
i) 25% less than the concentration point where no precipitate from the water insoluble surfactant and/or phase separation is visible in the aqueous solution, and
ii) 25% more than the concentration point where no precipitate from the water insoluble surfactant and/or phase separation is visible in the aqueous solution, or
iii) the concentration point where no precipitate of water insoluble surfactant and/or phase separation is visible in the aqueous solution.
   108. The method of paragraph 107, wherein the water insoluble surfactant is a nonionic and/or anionic surfactant, preferably a nonionic surfactant.
   109. The method of paragraph 107 or 108, wherein the point where no surfactant precipitate and/or phase separation is visible is determined at a temperature from 5° C. to 45° C. at pH 7 or pH 9, such as from 40 to 45° C. at pH 7 or pH 9.
   110. The method of any of paragraphs 107-109, wherein the point wherein no surfactant precipitate and/or phase separation is visible is determined at a temperature between 60° C. and 70° C. at pH 9, preferably 65° C., more preferably 67° C., more preferably 68° C., even more preferably 69° C., especially 70° C. at pH 9.
   111. The method of any of paragraphs 107-110, wherein the total concentration of surfactant is between 0.5 and 50 wt. %, or between 1 and 20 wt. %, or between 1 and 5 wt. %, or around 2 wt. %.
   112. The method of any of paragraphs 107-111, wherein the concentration of water insoluble surfactant is in the range between

a) 20%, preferably 10%, especially 5%, less than the concentration point where no surfactant precipitate and/or phase separation is visible in the aqueous solution, and

b) 20%, preferably 10%, especially 5%, more than the concentration point where no surfactants precipitate and/or phase separation is visible in the aqueous solution, or

c) the concentration point where no surfactant precipitate and/or phase separation is visible in the aqueous solution.

113. The method of any of paragraphs 107-112, wherein the water insoluble nonionic surfactant is an alcohol ethoxylate.
114. The method of paragraph 113, wherein the water insoluble nonionic surfactant is linear primary, or secondary or branched alcohol ethoxylate having the formula: RO(CH₂CH₂O)ₙH, wherein R has a chain length of C9 to C16 and n ranges from 0 to 5.
115. The method of paragraph 113, wherein the water insoluble nonionic surfactant is linear primary, or secondary or branched alcohol ethoxylate having the formula: RO(CH₂CH₂O)ₙH, wherein R has a chain length of C9-11 and n is 2.7.
116. The method of paragraph 115, wherein the water insoluble nonionic surfactant is Tomadol™ 91-2.5 or Bio-Soft™ N91-2.5.
117. The method of paragraph 107, wherein the anionic surfactant is water soluble.
118. The method of paragraph 117, wherein the water soluble anionic surfactant is one or more anionic surfactant selected from the group consisting of alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonate, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-N-alkyltaurates, and alkyl carboxylates.
119. The method of any of paragraphs 107-118, wherein the ratio between anionic surfactant and nonionic surfactant is in the range from 10:1 to 1:10, preferably 10:1 to 1:1, more preferably from 8:1 to 1:1, even more preferably 6:1 to 1:1.
120. The method of any of paragraphs 107-119, wherein the ratio between anionic surfactant and water insoluble nonionic surfactant is in the range from 10:1 to 1:10, preferably from 10:1 to 1:1, more preferably from 8:1 to 1:1, more preferably from 4:1 to 1:1.
121. The method of any of paragraphs 107-120, wherein the ratio between the water soluble nonionic surfactant and insoluble nonionic surfactants is in the range from 10:1 to 1:10, preferably from 1:10 to 1:1, more preferably from 1:6 to 1:1.
122. The method of any of paragraphs 107-121, wherein the ratio between anionic surfactant and total amount of nonionic surfactant is 10:1 to 1:10, preferably 10:1 to 1:1, such as 6:1 to 1:1.
123. A method of increasing the cleaning efficacy of a surfactant system or cleaning composition comprising one or more anionic surfactants and one or more nonionic surfactants, comprising the step of reducing the water solubility of the surfactant system or cleaning system by

a) introducing one or more salts into the surfactant system or cleaning composition, and/or

b) introducing one or more water insoluble surfactants into the surfactant system or cleaning composition.

124. The method of paragraph 123, wherein the water insoluble anionic surfactant is an anionic surfactant or a water insoluble anionic surfactant.
125. The method of paragraph 123 or 124, wherein the salt is a carbonate, preferably sodium carbonate or sodium bi carbonate, or a mixture thereof.

1-29. (canceled)

29. An aqueous surfactant system comprising one or more anionic surfactant and one or more nonionic surfactant.

30. The surfactant system of claim 29, wherein the ratio between anionic surfactant and nonionic surfactant is in the range from 10:1 to 1:10.

31. The surfactant system of claim 29, wherein the surfactant system comprises a water soluble anionic surfactant and/or a water insoluble anionic surfactant.

32. The surfactant system of claim 29, wherein the surfactant system comprises a water insoluble nonionic surfactant and/or water soluble nonionic surfactant.

33. The surfactant system of claim 29, comprising two or more nonionic surfactants and an anionic surfactant.

34. The surfactant system of claim 29, comprising two or more water-soluble nonionic surfactants and a water-insoluble nonionic surfactant.

35. The surfactant system of claim 29, comprising a water-soluble anionic surfactant, a water-soluble nonionic surfactant and a water-insoluble nonionic surfactant.

36. An aqueous surfactant system comprising one or more anionic surfactants and one or more salts, wherein one or more salts are present in an amount from 0.5 to 10 wt. %.

37. The surfactant system of claim 36, wherein the salt is selected from the group consisting of alkali metal salts of nitrates, acetates, chlorides, bromides, iodides, sulfates, hydroxides, carbonates, hydrogen carbonates, phosphates, sulfides, and sulfites; ammonium salts of nitrates, acetates, chlorides, bromides, iodides, sulfates, hydroxides, carbonates, hydrogen carbonates (also called bicarbonates), phosphates, sulfides, and sulfites; alkaline earth metal salts of nitrates, chlorides, bromides, iodides, sulfates, sulfides, and hydrogen carbonates; manganese, iron, copper, and zinc salts of nitrates, acetates, chlorides, bromides, iodides, and sulfates; citrates and borates, or mixtures thereof.

38. The surfactant system of claim 36, wherein the total amount of salt is between 0.8 to 8 wt. %.

39. The surfactant system of claim 29, wherein the water soluble anionic surfactant is one or more anionic surfactants selected from the group consisting of alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonate, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-N-alkyl taurates, and alkyl carboxylates.

40. The surfactant system of claim 29, wherein the water insoluble nonionic surfactant is glycol ether.

41. The surfactant system of claim 29, wherein the water insoluble nonionic surfactant is a linear primary, or secondary or branched alcohol ethoxylate having the formula: RO(CH₂CH₂O)ₙH, wherein R has a chain length of C9 to C16 and n from ranges from 0 to 13.

42. The surfactant system of claim 29, wherein the pH is in the range from 6-11.

43. An aqueous cleaning composition comprising a surfactant system of any of claims 29.
